(19) United States
(12) Patent Application Publication
(10) Pub. No.: US 2026/0261800 A1
(43) Pub. Date: Sep. 3, 2026

(54) SOUND PROCESSING METHOD AND SOUND PROCESSING DEVICE

(71) Applicant: YAMAHA CORPORATION, Hamamatsu-shi (JP)

(72) Inventors: Akio OHTANI, Tokyo (JP); Tadashi MORIKAWA, Hamamatsu-shi (JP); Katsumi ISHIKAWA, Hamamatsu-shi (JP); Daichi ISERI, Fukuroi-shi (JP); Kentaro NOTO, Hamamatsu-shi (JP)

(21) Appl. No.: 19/650,958

(22) Filed: Apr. 17, 2026

Related U.S. Application Data
(63) Continuation of application No. PCT/JP2024/032711, filed on Sep. 12, 2024.

(30) Foreign Application Priority Data
Oct. 19, 2023 (JP) 2023-180006

(51) Int. Cl. H04R 3/04; H04R 1/32; G10K 11/02

(52) U.S. Cl. CPC H04R 3/04; H04R 1/323; G10K 11/02; H04R 2430/01

(57) ABSTRACT

A sound processing method includes: acquiring position information on a virtual wall arranged in a virtual space; acquiring information including a first passage characteristic with respect to a sound that passes through the virtual wall along a first direction and a second passage characteristic with respect to a sound that passes through the virtual wall along a second direction opposite to the first direction, which are passage characteristics of the virtual wall with respect to the sounds; acquiring information on a sound source position and a listening position; determining one of the first passage characteristic and the second passage characteristic based on the sound source position, the listening position, and the position information on the wall; and performing sound processing on a sound signal from the sound source based on the determined passage characteristic.

### CROSS-REFERENCE TO RELATED APPLICATIONS

This is a continuation of International Application No. PCT/JP2024/032711 filed on Sep. 12, 2024, and claims priority from Japanese Patent Application No. 2023-180006 filed on Oct. 19, 2023, the entire content of which is incorporated herein by reference.

### TECHNICAL FIELD

One embodiment of the present disclosure relates to a sound processing method, and a sound processing device a program.

### BACKGROUND ART

Patent Literature 1 discloses a virtual sound insulation wall forming unit that insulates a sound from the outside and prevents sound emission to the outside.

Patent Literature 2 discloses an external information detection device in which a speaker is installed inside a soundproof chamber and a microphone is installed outside the soundproof chamber, so that an external sound can be heard in the soundproof chamber without emitting noise in the soundproof chamber to the outside.

Patent Literature 3 discloses a sound amplification area setting device that includes a detection unit for detecting division information obtained by dividing a space surrounded by walls into a plurality of rooms, and a sound amplification unit for amplifying an input audio signal in the space, in which a different audio signal is amplified for each of the divided rooms based on the division information.

### Citation List

### Patent Literature

Patent Literature 1: JP2010-107884

Patent Literature 2: Japanese Utility Model Registration No. 3089220

Patent Literature 3: JP2001-128298

### SUMMARY OF INVENTION

All of the inventions according to Patent Literatures 1 to 3 do not freely set passage characteristics of a sound emitted from a certain region to the outside thereof and a sound entering a certain region from the outside thereof.

An object of the present embodiment is to provide a sound processing method capable of freely setting a passage characteristic of a sound in accordance with a purpose.

A sound processing method according to an embodiment of the present disclosure includes: acquiring position information of a virtual wall arranged in a virtual space; acquiring sound passage information including: a first passage characteristic with respect to sound that passes through the virtual wall along a first direction; and a second passage characteristic with respect to sound that passes through the virtual wall along a second direction opposite to the first direction, which are passage characteristics of the virtual wall with respect to the sounds; acquiring position information that includes a sound source position and a listening position; determining a passage characteristic among the first passage characteristic and the second passage characteristic based on the sound source position, the listening position, and the position information on the wall; and performing sound processing on a sound signal from the sound source based on the determined passage characteristic.

According to one embodiment of the present disclosure, it is possible to freely set a passage characteristic of a sound in accordance with a purpose.

### BRIEF DESCRIPTION OF DRAWINGS

FIG. 1 is a block diagram illustrating a configuration of a PC 1;

FIG. 2 is a plan view illustrating a configuration of a virtual space;

FIG. 3 is a flowchart illustrating operations of a processor 34;

FIG. 4 is a list of passage characteristics of virtual walls;

FIG. 5 is a list of relations between a first passage characteristic and a second passage characteristic;

FIG. 6 is a plan view illustrating a configuration of a virtual space according to Modification 3;

FIG. 7 is a plan view illustrating a configuration of a virtual space according to Modification 5;

FIG. 8 is a plan view illustrating a configuration of a virtual space according to Modification 6; and

FIG. 9 is a plan view illustrating a configuration of a virtual space according to Modification 8.

### DESCRIPTION OF EMBODIMENTS

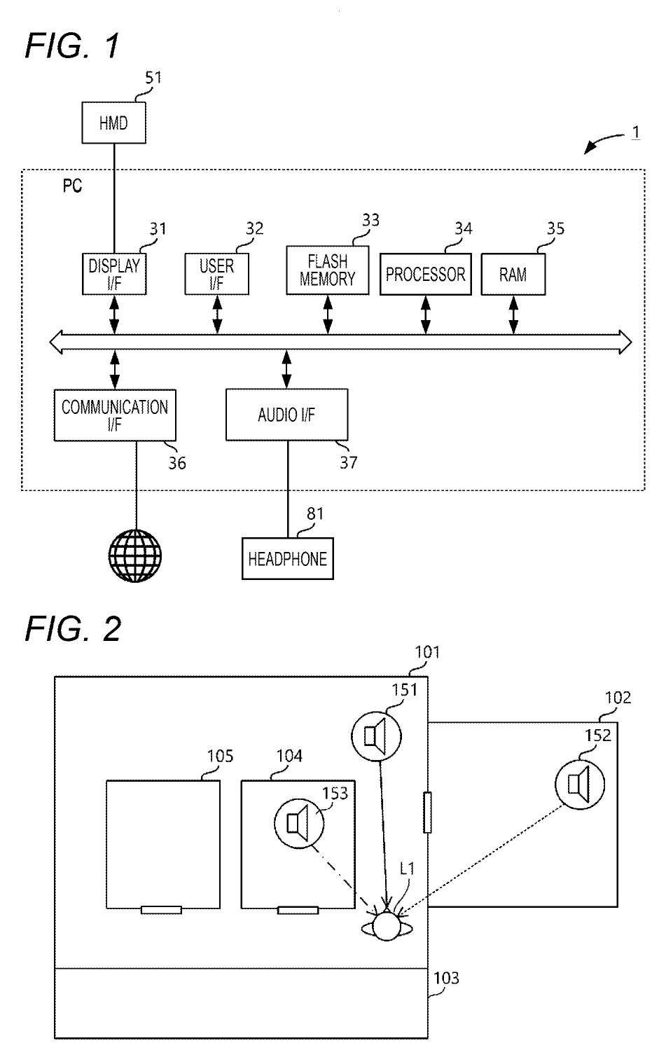

FIG. 1 is a block diagram illustrating a configuration of a PC 1. The PC 1 is an example of a sound processing device according to the present disclosure, and is a general-purpose information processing device. A user connects a head mounted display (HMD) 51 and a headphone 81 to the PC 1. The PC 1 includes a display interface (I/F) 31, a user I/F 32, a flash memory 33, a processor 34, a RAM 35, a communication I/F 36, and an audio I/F 37.

The display I/F 31 is connected to a display. The display I/F 31 of the PC 1 is connected to the head mounted display (HMD) 51 as an example of the display. In the present embodiment, the example in which the HMD 51 is connected to the PC 1 is shown, but the display such as an LCD may be connected to the PC 1.

The user I/F 32 is a keyboard, a mouse, or a touch panel laminated on the display. When the user I/F 32 is the touch panel, the user I/F 32 constitutes a graphical user interface (GUI) together with the display.

The communication I/F 36 includes a network interface, and is connected to a network such as the Internet via a router (not illustrated).

The audio I/F 37 includes an audio terminal. The audio I/F 37 is connected to an acoustic device via an audio cable. In the present embodiment, the headphone 81 is connected to the audio I/F 37 of the PC 1. The audio I/F 37 outputs a sound signal to the headphone 81.

The processor 34 includes a CPU, a DSP, a system-on-a-chip (SoC), or the like, reads a program stored in the flash memory 33 serving as a storage medium into the RAM 35, and controls components of various processing devices. The flash memory 33 stores, for example, a program according to the present embodiment.

The processor 34 decodes audio data received from another device such as a server via the communication I/F 36, and outputs a decoded sound signal to the audio I/F 37. The audio data transmitted by the another device such as a server includes a sound signal from a sound source arranged in a certain virtual space and position information on the sound source.

The processor 34 decodes video data received from the another device via the communication I/F 36, and outputs a decoded video signal to the display via the display I/F 31. The video data transmitted by the another device such as a server includes information related to the shape of the virtual space, position information on an object arranged in the virtual space, a CG image of the object, and the like. The information related to the shape of the virtual space (hereinafter referred to as space information) and the position information on the object are represented by three-dimensional coordinates with a certain position as an origin.

FIG. 2 is a plan view illustrating a configuration of the virtual space. The virtual space according to the example in FIG. 2 includes a lobby space 101, a conference space 102, a terrace space 103, a meeting space 104, and an exhibition space 105.

Each of the lobby space 101, the conference space 102, the terrace space 103, the meeting space 104, and the exhibition space 105 is formed by objects, that is, virtual walls arranged in the virtual space.

The processor 34 renders a CG image of the virtual space based on the position information on the object to generate a video of the inside of the virtual space viewed in a predetermined direction from a certain viewpoint position. The video data transmitted by the another device such as a server may be video data after rendering.

The processor 34 performs, on the sound signal from the sound source arranged in the virtual space, level reduction processing according to the position of the sound source and a listening position. The level of a sound from the sound source decreases in inverse proportion to the square of a distance from the sound source. In order to reproduce distance attenuation, the processor 34 performs, for example, the level reduction processing inversely proportional to the square of the distance according to the position of the sound source and the listening position. However, the level reduction processing is not necessarily inversely proportional to the square of the distance. For example, the processor 34 may perform the level reduction processing that is not attenuated at a position very close to the sound source, is inversely proportional to a distance at a medium distance, and is inversely proportional to the square of a distance at a long distance. In addition, the processor 34 may perform the level reduction processing based on a physical model representing level attenuation in terms of acoustic feeling according to the distance.

In addition, the processor 34 performs localization processing on the sound signal from the sound source arranged in the virtual space such that a sound image is localized at the position of the sound source. The processor 34 performs the localization processing based on, for example, a head related transfer function (HRTF). The HRTF represents a transfer function from a position of a certain virtual sound source to the right and left ears of the user. For example, as illustrated in FIG. 2, when viewed from a listening position L1, a first sound source 151 is positioned on the front side, a second sound source 152 is positioned on the front right side, and a third sound source 153 is positioned on the front left side. The first sound source 151 transmits, for example, a guidance voice flowing in the lobby space 101. The second sound source 152 transmits a voice of a speaker in the conference space 102. The third sound source 153 transmits a voice of a conference participant in the meeting space 104.

The processor 34 performs binaural processing to convolute a sound signal corresponding to the first sound source 151 based on the HRTF so as to localize the sound signal at a position on the front side of the user. In addition, the processor 34 performs the binaural processing to convolute a sound signal corresponding to the second sound source 152 based on the HRTF so as to localize the sound signal at a position on the front right side of the user. In addition, the processor 34 performs the binaural processing to convolute a sound signal corresponding to the third sound source 153 based on the HRTF so as to localize the sound signal at a position on the front left side of the user. However, as will be described later, since a sound from the third sound source 153 is insulated by wall surfaces of the meeting space 104, the processor 34 does not need to perform the localization processing based on the HRTF on the third sound source 153 when the listening position L1 is positioned outside the meeting space 104.

Accordingly, the user is at the listening position L1 in the virtual space and can perceive a feeling of listening to the sound from the first sound source 151 from the front side of the user. In addition, the user is at the listening position L1 in the virtual space and can perceive a feeling of listening to the sound from the second sound source 152 from the front right side of the user.

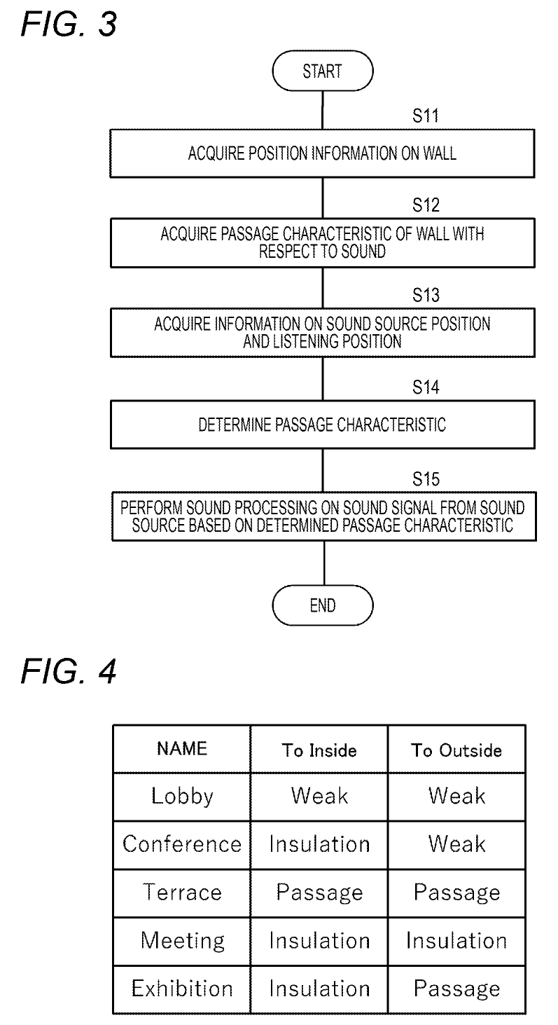

Further, the processor 34 performs sound processing based on the sound source position, the listening position, and position information on the wall. FIG. 3 is a flowchart illustrating operations of a sound processing method to be executed by the processor 34. The processor 34 acquires the position information on the virtual wall arranged in the virtual space (hereinafter referred to as the virtual wall) (S11). Further, the processor 34 acquires a passage characteristic of the virtual wall with respect to the sound (S12). The passage characteristic includes a first passage characteristic with respect to a sound that passes through the virtual wall along a first direction and a second passage characteristic with respect to a sound that passes through the virtual wall along a second direction opposite to the first direction.

FIG. 4 is a list of the passage characteristics of the virtual walls. The passage characteristics of the virtual walls constituting each of the lobby space 101, the conference space 102, the terrace space 103, the meeting space 104, and the exhibition space 105 are defined. The first passage characteristic with respect to the sound that passes through the virtual wall along the first direction is, for example, a passage characteristic (To Inside) with respect to a sound entering a space. The second passage characteristic with respect to the sound that passes through the virtual wall along the second direction opposite to the first direction is a passage characteristic (To Outside) with respect to a sound emitted from a space.

The passage characteristic includes a first characteristic "Insulation" indicating complete sound insulation, a second characteristic "Passage" indicating complete passage, and a third characteristic "Weak" other than the complete sound insulation and the complete passage.

For example, the first passage characteristic and the second passage characteristic of the lobby space 101 are defined as the same "Weak". The first passage characteristic of the conference space 102 is "Insulation" indicating the complete sound insulation, and the second passage characteristic of the conference space 102 is "Weak". The first passage characteristic and the second passage characteristic of the terrace space 103 are the same "Passage". The first passage characteristic and the second passage characteristic of the meeting space 104 are the same "Insulation". The first passage characteristic of the exhibition space 105 is "Insulation", and the second passage characteristic thereof is "Passage". Thus, the first passage characteristic and the second passage characteristic may be the same or different.

The processor 34 acquires information on the sound source position and the listening position (S13), and determines one of the first passage characteristic and the second passage characteristic based on the sound source position, the listening position, and the position information on the virtual wall (S14).

For example, according to the example in FIG. 2, the virtual wall of the lobby space 101 and the virtual wall of the conference space 102 are present between the second sound source 152 and the listening position L1. Therefore, the processor 34 determines the second passage characteristic (To Outside) of the conference space 102 as "Weak" and the first passage characteristic (To Inside) of the lobby space 101 as "Weak". In this case, the first passage characteristic (To Inside) and the second passage characteristic (To Outside) are the same "Weak". Therefore, the processor 34 determines the passage characteristic "Weak" for the sound signal from the second sound source 152.

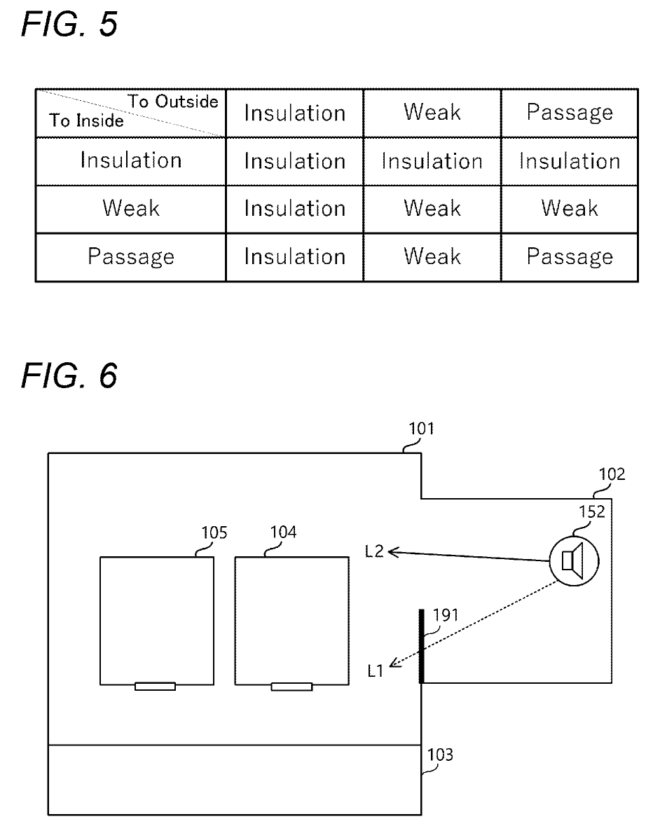

FIG. 5 is a list of relations between the first passage characteristic and the second passage characteristic. The processor 34 determines one of the first passage characteristic (To Inside) and the second passage characteristic (To Outside) based on the relations illustrated in FIG. 5. For example, when the first passage characteristic (To Inside) is "Insulation", the processor 34 determines that the first passage characteristic is "Insulation" even when the second passage characteristic is "Weak" or "Passage". Further, when the second passage characteristic (To Outside) is "Insulation", the processor 34 determines that the second passage characteristic is "Insulation" even when the first passage characteristic is "Weak" or "Passage". When the first passage characteristic (To Inside) is "Weak", the processor 34 determines that the first passage characteristic is "Weak" even when the second passage characteristic is "Passage". When the second passage characteristic (To Outside) is "Weak", the processor 34 determines that the second passage characteristic is "Weak" even when the first passage characteristic is "Passage".

For example, according to the example in FIG. 2, the virtual wall of the lobby space 101 and the virtual wall of the meeting space 104 are present between the third sound source 153 and the listening position L1. The processor 34 refers to the relation between the second passage characteristic (To Outside) "Insulation" of the meeting space 104 and the first passage characteristic (To Inside) "Weak" of the lobby space 101, and determines the passage characteristic "Insulation" with respect to the sound signal from the third sound source 153.

Further, according to the example in FIG. 2, there is no virtual wall between the first sound source 151 and the listening position L1. In this case, the processor 34 determines the passage characteristic "Passage" for the sound signal from the first sound source 151.

Then, the processor 34 performs the sound processing on the sound signal from the sound source based on the determined passage characteristic (S15). When the determined passage characteristic is "Insulation", the processor 34 performs mute processing on the sound signal from the sound source. When the determined passage characteristic is "Passage", the processor 34 causes the sound signal from the sound source to pass. When the determined passage characteristic is "Weak", the processor 34 performs filter processing on the sound signal from the sound source.

The filter processing includes at least low-pass filter processing. By the low-pass filter processing, the sound from the sound source passes through the wall and has a sound quality attenuated in a high band. In this case, the user can perceive the sound from the sound source as a sound that passes through the wall and is leaked and made audible. For example, the processor 34 performs the low-pass filter processing on the sound signal from the second sound source 152. Accordingly, the user can perceive the voice of the speaker that passes through the wall of the conference space 102 and is leaked and made audible.

Further, the filter processing may include reverberation processing. The reverberation processing reproduces a resonance in a space. A parameter for the reverberation processing is determined for each space. The processor 34 performs the reverberation processing on the sound signal from the first sound source 151 based on a parameter corresponding to the lobby space 101. Further, the processor 34 performs the reverberation processing on the sound signal from the second sound source 152 based on a parameter corresponding to the conference space 102. At this time, the processor 34 preferably does not perform the reverberation processing on the sound signal from the second sound source 152 based on the parameter corresponding to the lobby space 101. Accordingly, the user can more realistically perceive the voice of the speaker that passes through the wall of the conference space 102 and is leaked and made audible.

The filter processing is not limited to level attenuation processing such as the low-pass filter processing. For example, the filter processing may be amplification processing. Accordingly, the sound processing method according to the present embodiment can achieve a wall having an amplification performance and passage characteristics, which cannot be achieved in an actual space.

As illustrated in the example in FIG. 4, the first passage characteristic (To Inside) and the second passage characteristic (To Outside) of each space may be the same or different. For example, the first passage characteristic (To Inside) of the conference space 102 is "Insulation", and the second passage characteristic (To Outside) thereof is "Weak". Accordingly, the voice of the speaker in the conference space 102 is leaked and made audible outside the conference space 102, but a sound outside the conference space 102 cannot be heard when the user is in the conference space 102. Therefore, a person who administers a lecture business in the conference space 102 can attract the interest of the user outside the conference space 102 in the lecture by causing the user to hear the voice of the speaker. In addition, the user in the conference space 102 can concentrate on the lecture by not hearing the sound outside the conference space 102.

For example, the first passage characteristic (To Inside) and the second passage characteristic (To Outside) of the meeting space 104 are both "Insulation". Accordingly, a voice of a meeting in the meeting space 104 is not heard outside the meeting space 104, and a sound outside the meeting space 104 is not heard when the user is in the meeting space 104. Therefore, a person who holds the meeting in the meeting space 104 can concentrate on the meeting and secure confidentiality so that meeting contents cannot be heard.

Further, for example, by making the virtual walls constituting the meeting space 104 completely transparent, the meeting space 104 becomes an open space, and a sound insulation property thereof is ensured. That is, the sound processing method according to the present embodiment can achieve an open space having a sound insulation property, which cannot be achieved in an actual space.

For example, the first passage characteristic (To Inside) of the exhibition space 105 is "Insulation", and the second passage characteristic (To Outside) thereof is "Passage". Accordingly, the guidance voice and the like in the exhibition space 105 can be clearly heard outside the exhibition space 105, but a sound outside the exhibition space 105 cannot be heard when the user is in the exhibition space 105. Therefore, a person who uses the exhibition space 105 can attract the interest of the user outside the exhibition space 105 in exhibition contents by causing the user to hear the guidance voice. In addition, the person who uses the exhibition space 105 can cause the user in the exhibition space 105 to concentrate on appreciation of the exhibition contents by preventing the user from hearing the sound outside the exhibition space 105. That is, the sound processing method according to the present embodiment can achieve a light shielding wall that completely passes a sound therethrough, which cannot be achieved in an actual space.

As described above, the sound processing method according to the present embodiment can freely set the passage characteristic of the sound according to a purpose. Accordingly, the sound processing method according to the present embodiment can provide a novel customer experience, that is, various virtual walls that cannot be achieved by the related art, such as the light shielding wall for completely passing the sound therethrough and the open space for completely insulating the sound, can be formed.

### Modification 1

The filter processing may include first filter processing and second filter processing that have relatively different intensities.

The intensity refers to, for example, the level of a cut-off frequency in the low-pass filter processing. The higher the level of the cut-off frequency, the weaker the filter processing, and the lower the level of the cut-off frequency, the stronger the filter processing. For example, the user of the sound processing method according to the present embodiment sets a low cut-off frequency for a virtual wall having a high sound insulation property, and sets a high cut-off frequency for a virtual wall having a low sound insulation property.

Accordingly, a sound processing method according to Modification 1 can change the sound insulation property of the virtual wall.

### Modification 2

In the above embodiment, the processor 34 performs the sound image localization processing on the sound signal from the sound source based on the sound source position and the listening position, and performs, based on the determined passage characteristic, the sound processing on the sound signal subjected to the sound image localization processing. However, the processor 34 may perform the sound image localization processing on the sound signal after the sound processing based on the passage characteristic is performed.

Further, the sound image localization processing is not essential. For example, a sound having a sound quality reduced by the filter processing has a lower sense of localization than a sound in a case in which the filter processing is not performed. Therefore, for example, when the determined passage characteristic is "Weak", the processor 34 may not perform the binaural processing to convolute the sound signal from the sound source based on the HRTF. As described above, by omitting the sound image localization processing for a leakage sound having a reduced sound quality, a sound processing method according to Modification 2 can restrain an influence on the acoustic feeling of the user and can reduce the consumption of resources of the processor 34.

### Modification 3

In the above embodiment, the example is shown in which the first passage characteristic corresponds to a passage characteristic with respect to a sound that passes from a first region separated by the virtual wall to a second region different from the first region, and the second passage characteristic corresponds to a passage characteristic with respect to a sound that passes from the second region to the first region. That is, in the above embodiment, the example is shown in which the first characteristic corresponds to the passage characteristic (To Inside) with respect to the sound entering a certain region, and the second passage characteristic corresponds to the passage characteristic (To Outside) with respect to the sound emitted from a certain region.

However, it is not necessary to uniquely set the first passage characteristic and the second passage characteristic for each region. FIG. 6 is a plan view illustrating a configuration of a virtual space according to Modification 3. In the example in FIG. 6, a virtual wall 191 that separates the lobby space 101 and the conference space 102 is defined. However, the virtual wall 191 separates half of a boundary between the lobby space 101 and the conference space 102. Accordingly, as illustrated in FIG. 6, the sound from the second sound source 152 is perceived to be leaked and made audible at the listening position L1 separated by the virtual wall 191 when viewed from the position of the second sound source 152. At a listening position L2 visible from the position of the second sound source 152, the sound from the second sound source 152 is clearly heard.

### Modification 4

The sound source includes a sound source corresponding to a speaker fixed as a facility. For example, the first sound source 151 illustrated in FIG. 2 is a sound source corresponding to the speaker fixed as a facility. The processor 34 may perform processing for an acoustic characteristic of the speaker on the sound signal from the sound source corresponding to the speaker, and may perform the level reduction processing different from that of a sound source other than the speaker.

The processing for the acoustic characteristic of the speaker is, for example, high-pass filter processing or distortion processing. The high-pass filter processing or the distortion processing reduces a sound quality of the sound source. In general, a speaker fixed to a ceiling as a facility is a low-sound quality speaker with low clarity. The processor 34 according to Modification 4 can reproduce the sound quality of such a speaker fixed to the ceiling as a facility by performing the processing for the acoustic characteristic of the speaker.

In addition, the level reduction processing different from that of the sound source other than the speaker is processing for weakening the distance attenuation. As described above, the level reduction processing is processing for reducing the level in inverse proportion to the square of the distance from the sound source. However, by the level reduction processing for the speaker, the distance attenuation is weakened. Accordingly, the processor 34 can further reproduce the sound quality of the speaker fixed to the ceiling as a facility.

### Modification 5

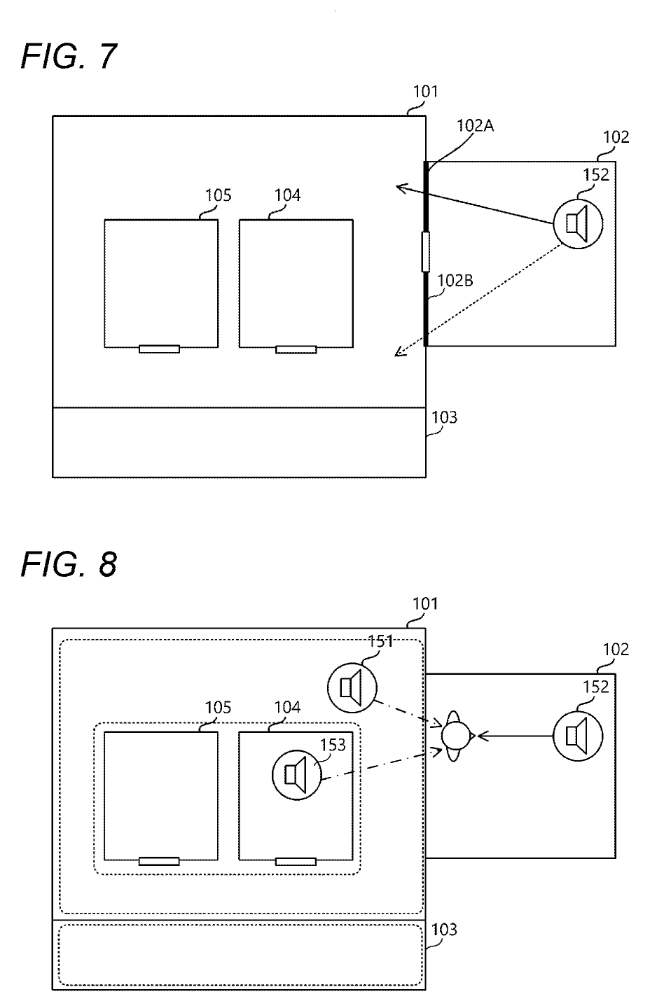

The sound source may include an environmental sound. FIG. 7 is a plan view illustrating a configuration of a virtual space according to Modification 5. In the example in FIG. 7, a sound source A of the environmental sound is defined in the entire lobby space 101, and a sound source B of the environmental sound is defined in the entire terrace space 103. For example, the sound source A of the environmental sound in the lobby space 101 is a BGM. The sound source B of the environmental sound in the terrace space 103 is a natural sound such as a crying sound of a small bird. It is preferable not to perform the localization processing for the sound source A and the sound source B of the environmental sound.

Accordingly, a sound processing method according to Modification 5 can reproduce atmosphere of a lobby or a terrace.

### Modification 6

In the above embodiment, the processor 34 performs first sound processing such as the mute processing or the filter processing on a sound signal related to a direct sound from the sound source based on the determined passage characteristic. However, the processor 34 may perform second sound processing on a sound signal related to an indirect sound from the sound source based on the determined passage characteristic.

FIG. 8 is a plan view illustrating a configuration of a virtual space according to Modification 6. In the example in FIG. 8, a door of the conference space 102 is opened, and an indirect sound from the second sound source 152 reaches the listening position L1. As the second sound processing, the processor 34 performs the localization processing such that the sound arrives from a reflection position of the second sound source 152 (the wall surfaces of the meeting space 104 in the example in FIG. 8).

Accordingly, the user can more realistically perceive not only the sound that passes through the walls of each space and is leaked and made audible, but also the sound that is a leakage sound and can be heard when the door is opened.

### Modification 7

The processor 34 according to Modification 7 acquires sound source information indicating the passage characteristic determined for each sound source. The processor 34 performs the sound processing on the sound signal from the sound source according to the passage characteristic based on the sound source information. That is, the passage characteristic may be determined for each sound source. For example, a conversation voice may be insulated by the walls of each space, and the environmental sound such as the BGM may pass through the walls of each space and may be leaked and made audible. Alternatively, the voice of the speaker may pass through the walls of each space and may be leaked and made audible, and voices other than the voice of the speaker may be insulated by the walls of each space.

Accordingly, a sound processing method according to Modification 7 can provide a novel customer experience, that is, various passage characteristics can be set for each sound source, such as a sound source that completely passes a sound or a sound source that completely insulates a sound.

### Modification 8

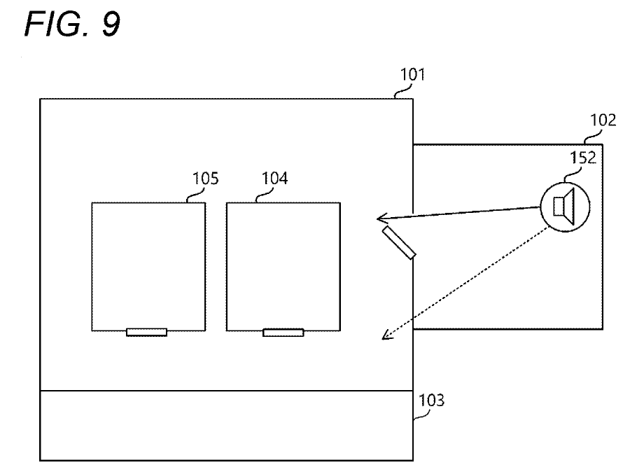

FIG. 7 is a plan view illustrating a configuration of a virtual space according to Modification 8. In the example in FIG. 7, the virtual wall of the conference space 102 includes a first virtual wall 102A and a second virtual wall 102B. The processor 34 acquires wall information indicating passage characteristics determined for the first virtual wall 102A and the second virtual wall 102B. The processor 34 performs the sound processing on the sound signal from the sound source according to the passage characteristic based on the wall information. For example, the wall information indicating the passage characteristic determined for the first virtual wall 102A in the example of FIG. 9 is "Passage" indicating the complete passage. The wall information indicating the passage characteristic determined for the second virtual wall 102B is "Weak". The processor 34 performs the filter processing on the sound signal from the second sound source 152 such that the sound from the second sound source 152 is leaked and made audible at the listening position L1 separated by the second virtual wall 102B when viewed from the position of the second sound source 152. The processor 34 passes the sound signal from the second sound source such that the sound from the second sound source 152 is clearly heard at the listening position L2 separated by the first virtual wall 102A when viewed from the position of the second sound source 152.

Accordingly, a sound processing method according to Modification 8 can provide a novel customer experience, that is, various passage characteristics can be set for each wall such as a wall that completely passes a sound therethrough and a wall that completely insulates a sound, even in the same space.

The description of the present embodiment should be considered to be illustrative in all respects and not restrictive. The scope of the present disclosure is indicated by the claims rather than the embodiments described above. Further, the scope of the present disclosure includes the scope equivalent to the claims.

What is claimed is:

1. A sound processing method, comprising:
acquiring position information of a virtual wall arranged in a virtual space;
acquiring sound passage information including:
a first passage characteristic with respect to sound that passes through the virtual wall along a first direction; and
a second passage characteristic with respect to sound that passes through the virtual wall along a second direction opposite to the first direction, which are passage characteristics of the virtual wall with respect to the sounds;
acquiring position information that includes a sound source position and a listening position;
determining a passage characteristic among the first passage characteristic and the second passage characteristic based on the sound source position, the listening position, and the position information on the wall; and
performing sound processing on a sound signal from the sound source based on the determined passage characteristic.

2. The sound processing method according to claim 1, wherein
the first passage characteristic and the second passage characteristic are different from each other.

3. The sound processing method according to claim 1, wherein:
each of the first and second passage characteristics includes one of a first characteristic indicating complete sound insulation, a second characteristic indicating complete passage, or a third characteristic other than the complete sound insulation and the complete passage,
in a case where the determined passage characteristic is the first characteristic, performing mute processing on the sound signal from the sound source,
in a case where the determined passage characteristic is the second characteristic, passing the sound signal from the sound source without processing the sound signal, and
in a case where the determined passage characteristic is the third characteristic, performing filter processing on the sound signal from the sound source.

4. The sound processing method according to claim 3, wherein
the filter processing includes first filter processing and second filter processing that have relatively different intensities.

5. The sound processing method according to claim 1, further comprising:
performing sound image localization processing on the sound signal from the sound source based on the sound source position and the listening position.

6. The sound processing method according to claim 1, wherein:
the first passage characteristic relates to sound that passes from a first region separated by the virtual wall to a second region different from the first region, and
the second passage characteristic relates to sound that passes from the second region to the first region.

7. The sound processing method according to claim 1, wherein:
the sound source corresponds to a speaker fixed as a facility, and
the sound processing method further includes:
processing based on an acoustic characteristic of the speaker; and
performing level reduction processing different from that of a sound source other than the speaker on the sound signal from the sound source corresponding to the speaker.

8. The sound processing method according to claim 1, wherein the sound source includes an environmental sound.

9. The sound processing method according to claim 1, wherein:
the sound signal includes:
a first sound signal relating to direct sound from the sound source; and
a second sound signal relating to indirect sound from the sound source, and
the sound processing method further comprises:
performing, on the first sound signal, first sound processing based on the determined passage characteristic; and
performing, on the second sound signal, second sound processing based on the determined passage characteristic.

10. The sound processing method according to claim 1, further comprising:
acquiring sound source information indicating a passage characteristic determined for each sound source,
wherein the sound processing to be performed on the sound signal from the sound source depends on the passage characteristic based on the sound source information.

11. The sound processing method according to claim 1, wherein:
the virtual wall includes a first wall and a second wall,
the sound processing method further includes acquiring wall information indicating passage characteristics determined for the first wall and the second wall, and
the sound processing to be performed on the sound signal from the sound source depends on the passage characteristic based on the wall information.

12. A sound processing device comprising:
a processor configured to:
acquire position information of a virtual wall arranged in a virtual space,
acquire sound passage information including:
a first passage characteristic with respect to sound that passes through the virtual wall along a first direction; and
a second passage characteristic with respect to sound that passes through the virtual wall along a second direction opposite to the first direction, which are passage characteristics of the virtual wall with respect to the sounds,
acquire position information that includes a sound source position and a listening position;
determine a passage characteristic among the first passage characteristic and the second passage characteristic based on the sound source position, the listening position, and the position information on the wall, and
perform sound processing on a sound signal from the sound source based on the determined passage characteristic.

13. The sound processing device according to claim 12, wherein the first passage characteristic and the second passage characteristic are different from each other.

14. The sound processing device according to claim 12, wherein:
each of the first and second passage characteristics includes one of a first characteristic indicating complete sound insulation, a second characteristic indicating complete passage, or a third characteristic other than the complete sound insulation and the complete passage,
the processor:
performs mute processing on the sound signal from the sound source in a case where the determined first or second passage characteristic is the first characteristic;
causes the sound signal from the sound source to pass without processing the sound signal, in a case where the determined first or second passage characteristic is the second characteristic; and
performs filter processing on the sound signal from the sound source, in a case where the determined first or second passage characteristic is the third characteristic.

15. The sound processing device according to claim 14, wherein the filter processing includes first filter processing and second filter processing that have relatively different intensities.

16. The sound processing device according to claim 12, wherein the processor performs sound image localization processing on the sound signal from the sound source based on the sound source position and the listening position.

17. The sound processing device according to claim 12, wherein:
the first passage characteristic relates to sound that passes from a first region separated by the virtual wall to a second region different from the first region, and
the second passage characteristic relates to sound that passes from the second region to the first region.

18. The sound processing device according to claim 12, wherein:
the sound source corresponds to a speaker fixed as a facility, and
the processor performs:
processing based on an acoustic characteristic of the speaker; and
performs level reduction processing different from that of a sound source other than the speaker on the sound signal from the sound source corresponding to the speaker.

19. The sound processing device according to claim 12, wherein the sound source includes an environmental sound.

20. A non-transitory computer-readable storage medium storing a program executable by a processor of a sound processing device to execute to a method comprising:
acquiring position information of a virtual wall arranged in a virtual space;
acquiring sound passage information including:
a first passage characteristic with respect to sound that passes through the virtual wall along a first direction; and
a second passage characteristic with respect to sound that passes through the virtual wall along a second direction opposite to the first direction, which are passage characteristics of the virtual wall with respect to the sounds;
acquiring position information that includes a sound source position and a listening position;
determining a passage characteristic among the first passage characteristic and the second passage characteristic based on the sound source position, the listening position, and the position information on the wall; and
performing sound processing on a sound signal from the sound source based on the determined passage characteristic.
